(19) United States
(12) Patent Application Publication
(10) Pub. No.: US 2020/0175465 A1
(43) Pub. Date: Jun. 4, 2020

(54) Distributed Shipment Prioritization Computing System

(71) Applicant: Neogrid Informátican S/A, Joinville (BR)

(72) Inventor: Miguel Abuhab, Joinville, SC (US)

(21) Appl. No.: 16/700,884

(22) Filed: Dec. 2, 2019

Related U.S. Application Data
(60) Provisional application No. 62/773,670, filed on Nov. 30, 2018.

(51) Int. Cl. G06Q 10/08; H04L 29/06

(52) U.S. Cl. CPC G06Q 10/087; H04L 63/083

(57) ABSTRACT

A shipment prioritization computing system may process inventory, order and/or shipping information to enable suppliers to prioritize product shipments to retailers and distributors to provide responsiveness and timely delivery of products to the correct destination on time. To do so, a cross-platform application programming interface may provide functions that may be integrated into different ERP computing systems to prioritize shipments by a sales order and/or a product identifier (e.g., a SKU). Such systems provide advantages in inventory management for manufacturing companies and may allow retailers (e.g., a consumer packaged goods company) to individualize inventory management and/or increase product turnover on a store-by-store basis.

### FIELD OF THE DISCLOSURE

This disclosure generally relates to computing systems and methods for prioritizing shipments across computing platforms, and specifically towards a distributed computing system implementing functions of an Application Programming Interface (API) including functions for efficient resource management and shipping.

### BACKGROUND

In order to organize, develop and control their resources, the manufacturing companies usually update daily their Enterprise Resource Planning (ERP) computing systems, with orders received from their customers. These ERP computing systems add a field in a data structure of an order record stored in a data repository. This field is used to indicate a priority for a particular shipment related to this order in relation to the other orders entered into the system for this product, or similar products. The field where the priority is indicated in the ERP computing system is a static information field.

In general, each company creates their own criteria to define a shipment priority, such as punctuality in payment by customers, customer representativeness, or others to define this field of priority. This leads to inconsistency and inefficiencies for shipment prioritization particularly when meeting shipping requirements to customers of manufacturing companies such as, for example, the availability of their products in retail outlets.

Currently, ERP systems do not have the visibility and control over a manufacturer's inventory and/or the sales of their products in retail chains. Also most ERP computing systems include proprietary protocols and interfaces and typically do not communicate with each other.

This could lead to losses, for example, in case of a failure to get of their products in the retail networks, there is loss of sales, or the retailer has to provide information communicating the loss or the risk of not providing of such products. Usually these communications are by e-mail, telephone or some other conventional means of communication. As such, a need has been recognized for improved systems and methods to allow cross platform communication and provide prioritization functions over a wide range of ERP computing systems.

### SHORT SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

The present disclosure sets forth systems and methods for shipment prioritization and cross platform ERP computing system communications including an API for Shipment Prioritization. The API disclosed herein is a set of routines and programming standards for capable of integration in multiple and/or different computing platforms. APIs allow integration of common functionality over a distributed network and provide a standard interface that may be easily understood and used by users of ERP computing systems. Often, APIs are used to merge multiple resources into one coherent and accessible solution.

The services described in this disclosure may be Representational State Transfer (REST) based, where written actions may be limited to hypertext transfer protocol (HTTP) requests of POST and query actions to GET requests. However, such implementations are illustrative and other functions and/or protocols may be contemplated.

In addition, the invention adjusts shipment prioritization using the Throughput Value Day (TVD) (risk value of sales loss) concept, in which a calculation is made to consider the gains and the number of days for product shortage risk, and including information on the manufacturing enterprise resource management systems.

To maintain a single priority criterion, retail networks are integrated into a single cloud system that allows the standard calculation of the TVD indicator, updating daily the priorities in the ERPs of the manufacturing companies based on inputs from the manufacturing system and/or the changing sales inputs from retail or distribution computing systems.

Another aspect of this disclosure is providing shipment prioritization algorithms that process existing inventory data, order data and the like using algorithms to output ideal inventory information (e.g., a level at each point of sale) on a periodic bases (e.g., daily, weekly, monthly, etc.) by capturing the inventory information and cross platform sales data.

These algorithms may compare the current inventory levels with ideal inventory levels, and identify and predict a risk of breakdown of each product's supply at one or more points of sale, thus allowing a centrally located computing system (e.g., a cloud computing system) to perform dynamic calculations for shipment priority. This information may be accessible and communicated through one or more API functions that can be accessed dynamically by networked ERP computing systems from manufacturing company computing systems, distribution center computing systems, retail outlet computing systems to update dynamically an open order's priority fields.

Additionally, the cloud computing system may take into account and calculate the priority field associated with any goods in transit already dispatched by the manufacturing company and not yet received by the retailer. Another advantage of the invention is being able to define the priority field from a monetization criterion that takes into account the needs of the retailer and product availability.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of an illustrative operating environment in which various aspects of the disclosure may be implemented in accordance with one or more aspects described herein;

FIG. 2 depicts an illustrative block diagram of workstations and servers that may be used to implement the processes and functions of certain aspects of the present disclosure in accordance with one or more aspects described herein;

FIG. 3 shows an illustrative block diagram of a distributed shipment prioritization computing system in accordance with one or more aspects described herein;

FIG. 4 shows an illustrative block diagram of a cloud-based computing systems in accordance with one or more aspects of the disclosure; and

FIG. 5 shows an illustrative user interface screen showing inventory and inventory buffer levels over time according to aspects to the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

For many businesses, when most free cash is tied up in inventory and product availability is an issue, improving inventory turnover is a significant need for that business. By improving turnover rates when all other parameters remain the same, would greatly increase operating efficiencies and maximize profit for the business. By switching from a forecast driven mode of operation to a consumption driven mode of operation inventory management and turnover improves by reducing shortages while reducing inventory levels. An application programming interface that may be integrated into retail and/or warehouse computing systems can leverage respective data sets to prioritize shipments and provide inventory visualizations. Such desire are not without challenges. For example, risks may include increased supplier measurement requirements, promotions at the end of the quarter, fewer relationships with suppliers and such relationships may be broken. Additionally, it may be difficult to sell such a “supply according to consumption” concept to suppliers, distributors, and/retailers due to difficulty in managing and coordinating disparate computing systems. In some cases, inventory may be out when the re open orders remaining and/or when no orders are present. In some cases, carrying an excess inventory and/or having low inventory turnover may be caused by a lack of visibility on inventories at multiple locations. To overcome these and other problems, an application programming interface that prioritizes shipments based on inventories with respect to sales orders and/or product identifiers can be integrated with ERP systems at suppliers, distributors and retailers to provide an overall view of the inventory structure across all computing platforms.

In some cases a shipment prioritization computing system may process inventory, order and/or shipping information to enable suppliers to prioritize product shipments to retailers and distributors to provide responsiveness and timely delivery of products to the correct destination on time. To do so, a cross-platform application programming interface may provide functions that may be integrated into different ERP computing systems to prioritize shipments by a sales order and/or a product identifier (e.g., a SKU). Such systems provide advantages in inventory management for manufacturing companies and may allow retailers (e.g., a consumer packaged goods company) to individualize inventory management and/or increase product turnover on a store-by-store basis.

In some cases, a VMI or automatic resupply offer may be a solution for a small number of retailers. However, few retailers have many vendors that can are capable of providing automatic inventory replenishment. The break in retail is high, and consequently there may be a loss of sales for manufacturing companies. ERPs define shipment priorities though an analysis of internal criteria and/or by observing a best location criterion. However, these ERP computing systems do not consider the risk of a potential loss of sales.

To ensure that there is no inventory supply break at the point of sale, the prioritization of order delivery by manufacturers must take into account the risk that a particular product may have a break in availability in the store. Based on this information, the manufacturers can better plan its delivery of orders to increase the turnover of its products and, at the same time, the retail outlets can increase the availability in these same goods, reducing both manufacturing and retail losses caused by the lack of the product.

For at least these reasons, a need was recognized to adjust the prioritization of shipment of the items of sales orders through use of calculated information, such as the Throughput Value Day (TVD) indicator. The TVD indicator relates to a value associated with the risk of loss of sales and may be calculated considering during the gain and the number of risk days of absence of the product. This criterion, and others, may be provided to the manufacturing ERP computing systems. To maintain a single priority criterion, retail computing systems may be integrated into a single cloud computing system with the manufacturing ERP computing system, to allow for a uniform calculation of the TVD indicator and/or provides periodic (e.g., daily) updates the priorities for use in the manufacturing companies' ERP computing systems. This is a new dimension to the supply chain where all retail networks are integrated manufacturing companies.

APIs

In some cases, organizations use microservices to encapsulate key capabilities within the organization in a scalable and reliable manner. Such microservices represent the important functional elements of enterprise information technology (IT) computing systems. But that's just part of the story, as these resources must have the ability to be exposed in a way that facilitates the solution of current technological business challenges—which is where the APIs come in.

Application Programming Interfaces are is a set of routines and programming standards capable of integration in numerous external applications to, for example, allow use of common functionality and provide a common interface over a wide range of applications and/or application suppliers. APIs often provide a common look and feel to user interfaces to an organizations information computing systems. Often, APIs are used to merge multiple resources into one coherent and accessible solution.

APIs can be likened figuratively to a “glue” that unites things—the mediator between your internal services and your external service consumers. By consuming the services of an API, the company can distribute its key customer-oriented functionalities, creating important experiences of user engagement across a wide variety of hardware platforms. These consumers can be other teams of the company itself, remote locations, important business partners or even outsourced, front-end and design teams.

In an illustrative “Priority of Shipping” API, the services may be REST-based, where write actions are limited to HTTP requests of POST, PUT and PATCH types, query actions to GET requests, and/or DELETE type removal. Other protocols and/or functionality may be contemplated without departing from the scope of this disclosure.

API Shipment Prioritization—Sales Orders

This illustrative API may provide microservices that provides information about the product's TVD and/or may allow the manufacturing computing system to prioritize the shipments based on a comparison of multiple retailers' needs.

Illustrative API functions are discussed below and may include functions that are associated with a product identifier and/or sales orders associated with a product. This function may provide SKU-based prioritization and may return a sum of the TVD calculated for a specified SKU. If, for example, a particular Warehouse is submitted, the TVD sum may also aggregate the sum of all the locations supplied by this Warehouse. An illustrative sales order function may return a sales order with the sum of TVD. This indicator may be used by a manufacture's computing system to help them to achieve a better prioritization. One or more models may be included in the API. These models may be parameters that the API needs to calculate the TVD for the SKU and/or the sales orders functions and may provide the structure that will be returned to the client.

The above-described examples and arrangements are merely some example arrangements in which the systems described herein may be used. Various other arrangements employing aspects described herein may be used without departing from the invention.

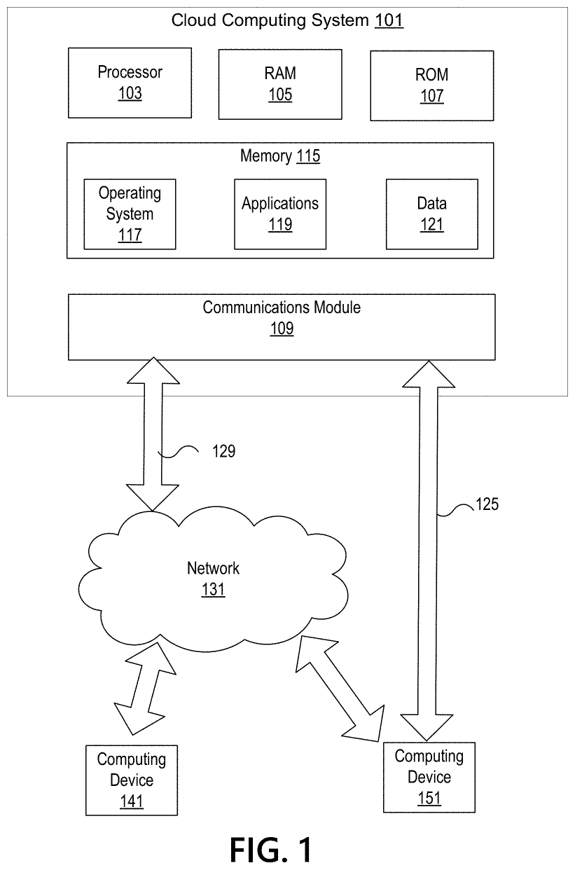

FIG. 1 depicts an illustrative operating environment 100 in which various aspects of the present disclosure may be implemented in accordance with one or more example embodiments. Referring to FIG. 1, the computing system environment 100 may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in illustrative computing system environment 100.

The computing system environment 100 may include the a cloud computing system 101 having a processor 103 for controlling overall operation of the cloud computing system 101 and its associated components, including a Random Access Memory (RAM) 105, a Read-Only Memory (ROM) 107, a communications module 109, and a memory 115. The cloud computing system 101 may include a variety of computer readable media. This computer readable media may be any available media that may be accessed by the cloud computing system 101, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by the cloud computing system 101.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on the cloud computing system 101. Such a processor may execute computer-executable instructions stored on a computer-readable medium.

Software may be stored within the memory 115 and/or storage to provide instructions to the processor 103 for enabling the cloud computing system 101 to perform various functions as discussed herein. For example, the memory 115 may store software used by the cloud computing system 101, such as an operating system 117, one or more application programs 119, API functionality, and at least one associated database 121. In addition, some or all of the computer executable instructions for the cloud computing system 101 may be embodied in hardware or firmware. Although not shown, the RAM 105 may include one or more applications representing the application data stored in the RAM 105 while the cloud computing system 101 is on and corresponding software applications (e.g., software tasks) are running on the cloud computing system 101.

The communications module 109 may include a microphone, keypad, touch screen, and/or stylus through which a user of the cloud computing system 101 may provide input, and may also include one or more of a speaker for providing audio output and a video display device for providing textual, audiovisual and/or graphical output. The computing system environment 100 may also include one or more optical scanners (not shown).

The cloud computing system 101 may operate in a networked environment supporting connections to one or more remote computing devices, such as the computing devices 141 and 151. The computing devices 141 and 151 may be personal computing devices or servers that include any or all of the elements described above relative to cloud computing system 101.

The network connections depicted in FIG. 1 may include a Local Area Network (LAN) 125 and/or a Wide Area Network (WAN) 129, as well as other networks. When used in a LAN networking environment, the cloud computing system 101 may be connected to the LAN 125 through a network interface or adapter in the communications module 109. When used in a WAN networking environment, the cloud computing system 101 may include a modem in the communications module 109 or other means for establishing communications over the WAN 129, such as via a network 131 (e.g., public network, private network, Internet, intranet, and the like). The network connections shown are illustrative and other means of establishing a communications link between the computing devices may be used. Various protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

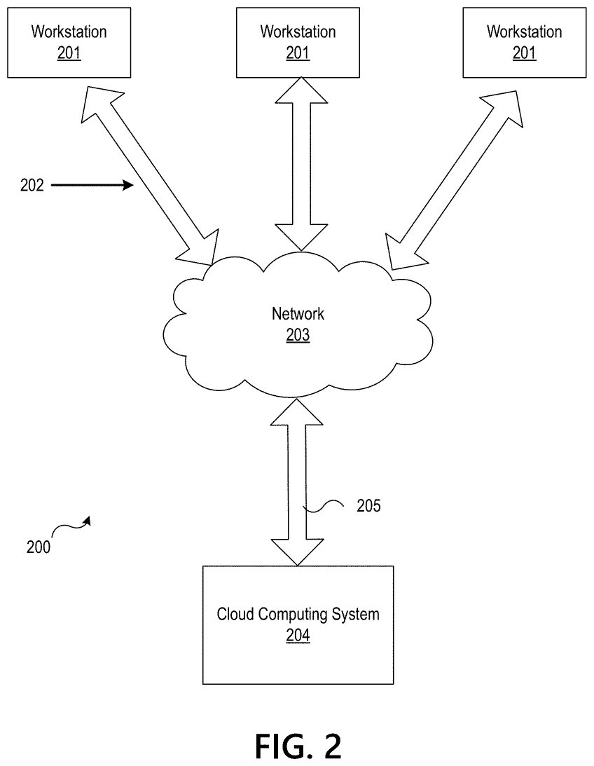

FIG. 2 shows an illustrative block diagram of workstations and servers that may be used to implement the processes and functions of certain aspects of the present disclosure in accordance with one or more example embodiments. Referring to FIG. 2, an illustrative system 200 may be used for implementing example embodiments according to the present disclosure. As illustrated, the system 200 may include one or more workstation computers 201. The workstation computers 201 may be, for example, a desktop computer, a server, a smartphone, a wireless device, a tablet computer, a laptop computer, and the like, configured to perform various processes described herein. The workstations 201 may be local or remote, and may be connected by one of the communications links 202 to the computer network 203 that is linked via communications a link 205 to the cloud computing system 204. In the system 200, the cloud computing system 204 may be a server, processor, computer, or data processing device, or combination of the same, configured to perform the functions and/or processes described herein. The cloud computing system 204 may be used to coordinate operation of shipment priority API functions that may be integrated into ERP computing systems at remote devices, and the like.

The computer network 203 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. The communications links 202 and 205 may be communications links suitable for communicating between workstations 201 and cloud computing system 204, such as network links, dial-up links, wireless links, hard-wired links, as well as network types developed in the future, and the like.

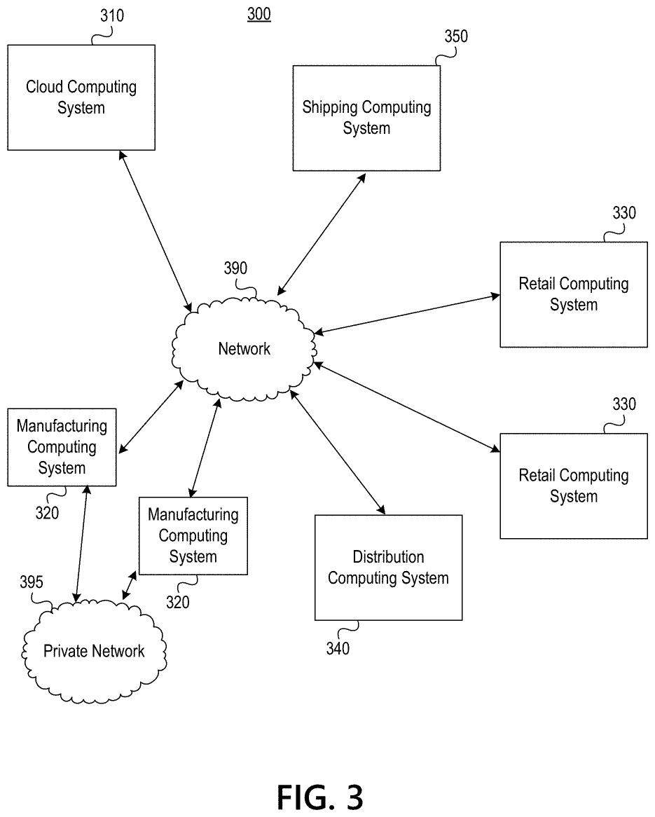

FIG. 3 shows an illustrative block diagram of a distributed shipment prioritization computing system 300 in accordance with one or more aspects described herein. For example, the illustrative distributed shipment prioritization computing system 300 may include a cloud computing system 310, one or more manufacturing computing systems 320, one or more retail computing systems 330, one or more distribution computing systems 340, and one or more shipping computing systems 350, which may be communicatively coupled via one or more networks, such as a public network 390 (e.g., the internet) and/or one or more private networks 395. Each of the cloud computing system 310, the one or more manufacturing computing systems 320, the one or more retail computing systems 330, the one or more distribution computing systems 340, and the one or more shipping computing systems 350 may include one or more of the computing devices and/or networks illustrated in FIGS. 1 and 2. In some cases, each of the one or more manufacturing computing systems 320, the one or more retail computing systems 330, the one or more distribution computing systems 340, and the one or more shipping computing systems 350 may process an enterprise resource planning (ERP) or other enterprise management computing systems to manage production activities, retail activities, sales activities and/or inventory management activities. In some cases, each of the ERP systems may be different and may not be compatible, such that information cannot be easily communicated between systems. As such, production, distribution, warehousing, retail, and/or sales activities may be difficult to coordinate between the different systems. In such cases, an application programming interface may be provides, such as by the cloud computing system 310, to allow integration of API function calls into one or more enterprise resource management systems to facilitate order prioritization, inventory management, product manufacturing activities, product warehousing activities, and/or shipping activities throughout different geographic locations and/or different organizations.

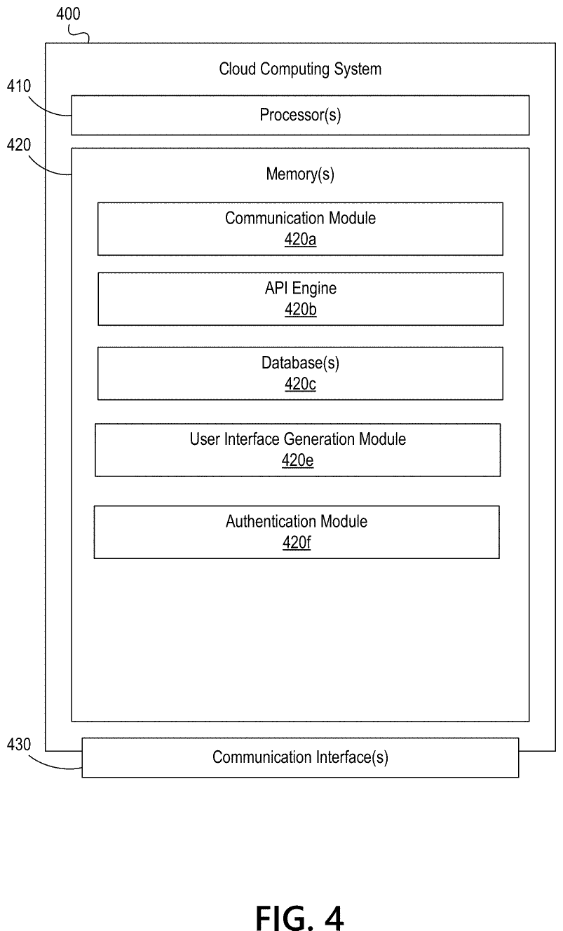

FIG. 4 shows an illustrative block diagram of a cloud-based computing system 400 in accordance with one or more aspects of the disclosure. For example the cloud-based computing system 400 facilitates use of an application programming interface for order prioritization, transferring one or more products between geographical locations, and/or manufacturing products based on inventory and/or order requirements based on current conditions and/or predicted conditions at one or more geographical locations. For example, the cloud-based computing system may include one or more processors 410, one or more memory devices (e.g., memory 420), storing instructions that, when executed by the one or more processors 410, cause the cloud computing system 400 to operate a communication module 420a, an API engine 420b, one or more database 420c, a user interface generation module 420e and/or an authentication module 420f The communication module 420a may be configured to allow the cloud computing system 400 to communicate via one or more networks (e.g., the Internet, a WAN, a LAN, a telecommunications network, etc.), such as via one or more communications interface(s) 430.

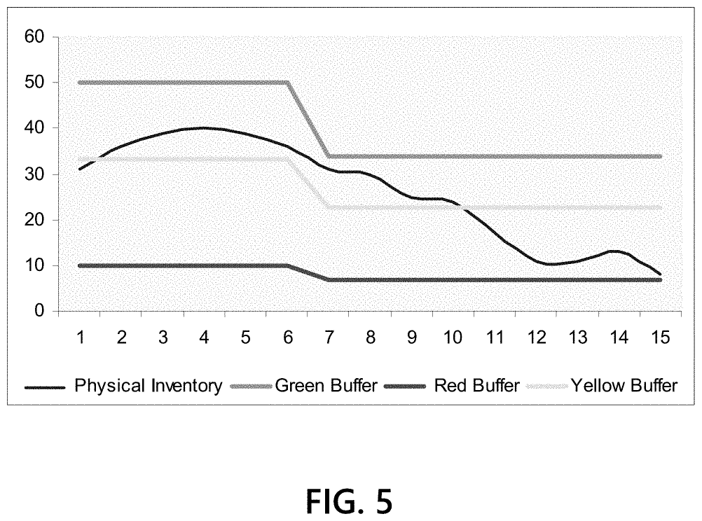

The database(s) 420c may be based on one or more database management systems, such as a relational database, a hierarchical database, object databases, and the like. the databases 420c may be used to store and/or manipulate data received from the one or more different computing systems communicatively coupled to the cloud-based computing system 410. The user interface generation module 420e may be configured to generate one or more user interface screens and/or to otherwise format data for presentation at a remote computing system (e.g., the one or more manufacturing computing systems 320, the one or more retail computing systems 330, the one or more distribution computing systems 340, and the one or more shipping computing systems 350, etc.) For example, the API engine 420b may process instructions from one or more remote computing systems to return information for presentation to a user (e.g., predicted information, historical information, current information, and the like), such as order information and/or inventory information corresponding to a prioritization request. In some cases, the user interface generation module 420e may return a user interface screen, such as the one shown in FIG. 5. For example, FIG. 5 shows an illustrative user interface screen showing inventory and inventory buffer levels over time according to aspects to the disclosure. For example, a maximum buffer level may be associated with an expected demand during a particular product lead-time. A minimum buffer level may be associated with a minimum inventory level available to cover a product demand and/or offer variation. In some cases, the buffer levels may vary dynamically over time. The illustrative user interface screen of FIG. 5 may include a physical inventory representation that may vary over time. The user interface may be configured as a plot of inventory (amount) vs time (days), but could be configured in other representations including one or more bar graphs, pie charts, number fields, and the like.

The cloud computing system 310 may comprise one or more components of the cloud-based computing system 410. For example, the cloud computing system 310 may be configured to facilitate use of API functionality, as called from one or more computing devices of the manufacturing computing system 320, the retail computing system(s) 330, the distribution computing system 340, and/or the shipping computing system 350. In some cases, the API engine 420e of the cloud computing system 310 may pull information (e.g., order information, inventory information, sales order information, and the like) and/or request data from one or more of the manufacturing computing system 320, the retail computing system(s) 330, the distribution computing system 340, and/or the shipping computing system 350.

In some cases, the authentication module 420f may be configured to manage user authentication and/or data security operations to protect the information communicated between computing systems. For example, the authentication module 420 may be configured to facilitate data encryption functionality for messages communicated via the communication module 420a. For example, an API function call may initiate creation of a secure communication token by the authentication module 420f that is to be returned to the computer system initiating the function call. This token may be used to authenticate communications between the computing systems and may be used to open a communication channel for a specified period of time (e.g., 5 minutes, 10 minutes, 1 hour, and the like). If a message is received with an expired token, or otherwise invalid, communication is halted between the computing systems and a failure code is returned.

The API engine 420b may be configured to provide different prioritization functionality. For example, a first function may correspond to order prioritization of a plurality of sales orders entered into one or more computing devices of the manufacturing computing system 320, the retail computing system(s) 330, the distribution computing system 340, and/or the shipping computing system 350. In some cases, the function call may include one or more input parameters, such as an industry type parameter, a product identifier parameter, a supply chain location parameter (e.g., retail, distribution, warehouse, manufacture, etc.). In some cases, the function may filter and/or configure the returned information based on the number and/or type(s) of input parameters used. For example, the function call may filter returned information based on the input parameters, such as by returning all information corresponding to an industry when only an industry is specified. In some cases, use of a retail/distribution parameter may return information corresponding to all products at a location associated with an provided retail/distribution identifier. When a retail/distribution parameter is used with a product identifier parameter, the API function may return locations at which orders associated with the specified product identifier must be prioritized. As part of the API function processing, the authentication module may allow access only to the request associated with a valid token. In some cases, the token information is included as an input to the function call and/or may be associated with a different function call. If the token is not valid, an error may be returned. For example, if the token is expired an error is returned. Since each industry has its own data store, the API engine connects dynamically to the databases to consume the requested information (e.g., priority information), and the connection remains active for a period of time. After the timeout, the connection is terminated and the resources are released.

The API engine 420b may be configured to perform dynamic buffer management functionality based on a received API function call received from one of a plurality of connected computing systems. In some cases, the API engine 420b may cause a transfer of inventory from a first storage location to a second storage location (e.g., from a first warehouse or distribution center to a second warehouse or distribution center, from a distribution center to a retail location, from a first retail location to a second retail location and/or the like). In some cases, the API engine may return an quantity of inventory to transfer, a source location and/or a destination location. In some cases, the API engine may automatically trigger the transfer of products from a first location to a second location based on a returned value. In some cases, the return value corresponds to a prioritization of sales orders received at a geographic location (e.g., a retail location, a distribution center, etc.). Illustrative API function calls may include a function to calculate and return a priority value associated with a particular product identifier (e.g., a SKU) at a location, a function to calculate and return a priority value for one or more sales orders. For example, sales order priority function may receive inputs corresponding to a part number, a sales order number, a destination and may calculate and return a sales order number, a sales order priority value and a priority value for a supplied amount of product (e.g., orderNumber, SalesOrderTVDamount, SalesOrderSuppliedTVDAmount). In some cases, the product priority function may receive an input parameter associated with a product identifier and/or a location code, and may calculate and return at least a product identifier, a priority value associated with the product at the location, and a priority value associated with supplied product from the location (e.g., itemCode, itemName, locationTVDAmount, location SuppliedTvdAmount).

In some cases, the database(s) 420c may include a plurality of fields, such as a minimum stock field, a security stock field, an optimal stock field, a maximum stock field, a first buffer time field, a second buffer time field. In an illustrative example, the fields may include:
vl_min_stock: Inventory equivalent to inventory 0, the lowest level of inventory the product can reach, is considered the “Black Buffer”.
vl_security_stock: an inventory level associated with a retailer or other inventory location, such that the organization will not have operation jeopardized. Inventory values below this level presents risk of a shortage if no action is taken. This is the “Red Buffer”.
vl_optimal_stock: Ideal stock level for operation is “Yellow Buffer”.
vl_max_stock: Also known as norm, which is the maximum inventory representative of the largest amount of inventory to be held by retailers or other inventory locations.
vl_green_buffer_penetration: Indicator used as a parameter to identify the exposure time of the product in the Red Buffer.
vl_red_buffer_penetration: Indicator used to identify the exposure time of the product to the Green Buffer.

In some cases, the API engine 420b may use one or more temporary variable in the calculations for dynamic buffer management, such as an integer parameter (vl_days_with_stock_and_no_sales) tracking days with stock and no sales and only considering days when stock is present. Another temporary variable may correspond to available stock (e.g., vl_available_stock), which may be calculated as vl_available_stock=vl_quantity_in_stock+vl_stock_in_transfer−vl_stock_reserved. In some cases, vl_days_with_stock_and_no_sales may correspond to a number of inventory days greater than 0 and between two time periods with sales. In some cases, vl_green_buffer_penetration may be calculated with the formula:

IF vl_quantity_in_stock BETWEEN vl_optimal_stock AND vl_max_stock

previous vl_buffer_green_penetration + ((vl_quantity_in_stock −
vl_optimal_stock ) / (vl_max_stock − vl_optimal_stock))

ELSE NULL;

In some cases, vl_red_buffer_penetration may be calculated with the formula

IF vl_quantity_in_stock < vl_security_sock

vl_red_buffer_penetration + ABS(vl_quantity_in_stock − vl_security_stock
+ vl_to_be_out_of_stock) / (vl_security_stock + vl_to_be_out_of_stock)

ELSE: NULL

In some cases, vl_max_stock may be calculated with the formula:

If: (the product is offline or phase out)

vl_max_stock = null

Else: (If there is an active season allocation, saves current norm and thenassigns

allocated value in the configuration to the norm)

vl_max_stock_prev_allocation = vl_max_stock; vl_max_stock=
vl_allocation

Else: (If it is the first end day of an allocation and has to restore the norm tothe pre-
season version, restores)

vl_max_stock = vl_max_stock_prev_allocation

Else: (If the product has initial allocation set, it assumes)

If: (the product has no norm yet assumes the highest values betweenLead
Time vs Average Demand or Inventory on Date)
• Calculate Norm Area:

| • | if(vl_quantity_in_stock <= bl_black_bufer) |
|---|---|
| | BLACK |
| • | else if (vl_quantity_in_stock > vl_black_buffer&& |

vl_quantity_in_stock <= vl_safe_stock)
RED

| | |
|---|---|
| • | else if (vl_quantity_in_stock > vl_safe_stock&& |

vl_quantity_in_stock <= vl_optimal_stock )
YELLOW

| | |
|---|---|
| • | else if (vl_quantity_in_stock <= vl_max_stock&& |

vl_quantity_in_stock > vl_optimal_stock )
GREEN

| | |
|---|---|
| • | else if (vl_quantity_in_stock > vl_max_stock ) |

BLUE

In some cases, the API engine 420b may calculate “Norm Area” according to the previous step, but this time instead of using an inventory value, the API module 420b may use inventory and demand. Here, if the function call for a product returns RED or BLACK, in the stock area calculation but does not return these values when calculating the stock and demand area, reset the red penetration limit (e.g., vl_red_buffer_penetration). If, the function returns a value in the red area and is not associated with small targets, update the red penetration area calculation (e.g., vl_red_buffer_penetration). If the current penetration is greater than the limit and the previous penetration is less than the limit, update the norm calculation (e.g., vl_max_stock*BUFFER_INCREASE_FACTOR). If the value is in the red area and is associated with small targets, and if stock days is less than the stock days limit between sales, add one unit to stock (e.g., vl_max_stock=vl_max_stock+1). To calculate the norm area, the API Engine 420b may process a norm function such as:

if(vl_quantity_in_stock <= bl_black_bufer)

BLACK

else if (vl_quantity_in_stock > vl_black_buffer && vl_quantity_in_stock <=
vl_safe_stock)

RED

else if (vl_quantity_in_stock > vl_safe_stock && vl_quantity_in_stock <=
vl_optimal_stock )

YELLOW

else if (vl_quantity_in_stock <= vl_max_stock && vl_quantity_in_stock >
vl_optimal_stock )

GREEN

else if (vl_quantity_in_stock > vl_max_stock )

BLUE

In some cases, the API Engine 420b may further calculate norm Area as above, using a sum of inventory and demand. If the Product Returns RED or BLACK in the stock area calculation but does not return these values when calculating the stock and demand area, the function resets the red penetration limit (e.g., vl_red_buffer_penetration). If the value is in the red area and it is not associated with small targets, the function updates the red penetration area calculation (e.g., vl_red_buffer_penetration). If the current penetration is greater than the limit and the previous penetration is less than the limit, the function performs the norm update calculation (e.g., vl_max_stock*BUFFER_INCREASE_FACTOR). If the value is in the red area and is associated with small targets, calculate the norm area using a sum of inventory and demand. Further, if stock days is less than the stock days limit between sales, add one unit to stock (e.g., vl_max_stock=vl_max_stock+1). If the value is in the green area, the function updates the green penetration area calculation (e.g., vl_green_buffer_penetration). If the current penetration value is greater than the limit and the previous penetration value is less than the limit, then decrease the maximum stock value for the buffer (e.g., vl_max_stock*BUFFER_DECREASE_FACTOR), else keep the current norm value (e.g., vl_max_stock). If norm has changed, the function recalculates its area, and if the color is different from the previous one, resets the penetration calculations:

vl_green_buffer_penetration=0&&vl_red_buffer_penetration=0

vl_optimal_stock=vl_max_stock*(2f/3f)

vl_security_stock=vl_max_stock*(1f/3f)

In some cases, the API engine 420b may use a different inventory formula focusing on safety stock (e.g., vl_security_stock) and may generate other stock values based on the safety stock value (e.g., vl_optimal_stock, vl_max_stock, etc.).

Δ=(vl_sale_std_dev²*vl_replenishment_stock_lt_yearly_mean)+((vl_replenishment_stock_lt_yearly_mean*0.2)²*vl_average_demand_truncated²)

vl_security_stock=constant_service_level*√Δ

vl_optimal_stock=vl_max_stock*2f

vl_max_stock=vl_security_stock*3.03f

In some cases, the API engine 420b may calculate a suggested value:

| | |
|---|---|
| • | vl_available_stock = vl_quantity_in_stock + vl_stock_in_transfer − vl_stock_reserved |
| • | vl_order_suggestion = IF vl_max_stock < vl_small_max_stock |

vl_max_stock

ELSE

ROUND(vl_max_stock − vl_available_stock)

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A distributed computing system for prioritizing shipments, comprising
a cloud computing device comprising a processor and a non-transitory memory device storing instructions that, when executed by the processor, cause the cloud computing device to:
receive, from a warehouse computing system, a request from an instance of a shipment prioritization function with respect to a product, wherein the call comprises a security token;
authenticate, by an authentication module, the security token;
identify, based on an open communication channel in response to authentication of the token, a first inventory value of a product at a first location;
identify a second inventory value of the product at a second location;
calculate a shipping priority value;
return the shipping priority value to the instance of the shipment prioritization function at the warehouse computing system; and
close, based on an expiration of a period of time, the communication channel.

2. The distributed computing system of claim 1, wherein the instructions further cause the cloud computing device to:
calculate a desired inventory value for the first location; and
calculate a desire inventory value for the second location.

3. The distributed computing system of claim 1, wherein the first location comprises a retail location and the second location comprises a warehouse location.

4. The distributed computing system of claim 1, wherein the first location comprises a distribution location and the second location comprises a warehouse location.

5. The distributed computing system of claim 1, wherein the instructions further cause the cloud computing device to:
receive order information comprising a plurality of orders for the product;
based on inventory values of at least the first location and the second location, calculate a priority for each of the plurality of orders; and
trigger shipment, by the warehouse computing system, prioritized shipment of each of the plurality of orders based on the priority for each of the plurality of orders.

6. The distributed computing system of claim 1, wherein the shipment prioritization function comprises a SKU based prioritization function.

7. The distributed computing system of claim 1, wherein the shipment prioritization function comprises a sales order based prioritization function.

8. The distributed computing system of claim 1, wherein the instructions further cause the cloud computing device to:
calculate, a TVD value associated with inventory of the product at each of a plurality of retail locations based on information retrieved from a retail computing system.

9. The distributed computing system of claim 1, wherein the instructions further cause the cloud computing device to:
calculate, a TVD value associated with inventory of the product at one or more distribution locations based on information retrieved from a distribution computing system.

10. The distributed computing system of claim 1, wherein the instructions further cause the cloud computing device to:
calculate, a TVD value associated with inventory of the product at one or more warehouse locations based on information retrieved from the warehouse computing system.

11. The distributed computing system of claim 1, wherein the instructions further cause the cloud computing device to:
cause display, at a user device, of a dynamic buffer management screen indicating at least one inventory buffer value indicators and at least one inventory level indicator.

12. The distributed computing system of claim 1, wherein the instructions further cause the cloud computing device to:
cause display, at a user device, of a dynamic buffer management screen indicating at least one inventory buffer value indicators and at least one inventory level indicator wherein a first buffer level corresponds to a minimum desired inventory level, and a second buffer level corresponds to a maximum desired inventory level and the at least one inventory indicator comprises a dynamically updated representation of a current inventory level at a given time.
